(19) United States
(12) Patent Application Publication
(10) Pub. No.: US 2025/0038458 A1
(43) Pub. Date: Jan. 30, 2025

(54) ELECTRICAL CONNECTOR WITH ASSISTED MATING AND OVERLAPPING COURSE, AND METHOD FOR ASSEMBLING IT WITH ITS COUNTER-CONNECTOR

(71) Applicant: Aptiv Technologies AG, Schafhausen (CH)

(72) Inventors: Norbert DOBERNIG, Lauf (DE); Mirko POSMIK, Fürth (DE)

(21) Appl. No.: 18/779,881

(22) Filed: Jul. 22, 2024

(30) Foreign Application Priority Data
Jul. 28, 2023 (EP) 23188554.2
Aug. 21, 2023 (EP) 23192532.2

(51) Int. Cl. H01R 13/629; H01R 13/502; H01R 13/639; H01R 43/26

(52) U.S. Cl. CPC H01R 13/62955; H01R 13/502; H01R 13/62938; H01R 13/639; H01R 43/26

(57) ABSTRACT

A connector system includes a connector housing with electrical contacts for engaging counter-contacts of a counter-connector. The system features a lever mechanism with a lever arm connected to the housing via a joint, enabling movement between open and closed positions. In the open position, the counter-connector can be partially mated, while in the closed position, full mating is achieved. The lever includes a securing portion extending through an opening in the housing wall to secure the lever in place. This design facilitates the mating process between the connector and counter-connector, ensuring a reliable and secure electrical connection.

### CROSS-REFERENCE TO RELATED APPLICATION

This application claims the benefit of and priority to European Patent Application No. 23177554.2 filed on Jul. 28, 2023, and European Patent Application No. 23192532.2 filed on Aug. 31, 2023, the contents of each of which are incorporated by reference herein.

### TECHNICAL FIELD

The disclosure relates to the field of electrical connection systems, especially for power connection for motor vehicles. For example, the disclosure can find an application in power connectors, such as those used to charge a rechargeable electric or hybrid vehicle battery or as those used in interconnect power circuits connecting batteries, converters, electrical motors, and any other power device of a vehicle.

### BACKGROUND

Connectors are used to assemble several previously made elements, mostly cables or “harnesses”, in order to make a connection between them that allows electrical energy and/or signals to be transmitted between these elements. These elements can each be a cable or a motor or another type of device such as a computer or a sensor or a lighting device. For clarity reasons, the term “cable” will be used here, but it should be understood that it may include other kinds of to-be-connected elements. According to the need, such connectors may have electrical contacts in greater or lesser number and in greater or lesser size.

When the connector mounted on one cable is mated with another connector, which can be called a counter-connector, usually of a different and for example complementary type, its electrical contacts are themselves mated with corresponding counter contacts on the other side of the connection that are mounted in the counter connector.

Such a connector often comprises a mobile lever, which may have various functions depending on the design of the connector. A lever may be arranged so as to provide a coupling aid, where an action on the lever generate an effort that bring connector and counter connector closer to each other. A lever may also be arranged so as to lock the connector and counter connector together, by preventing them from moving off from each other. Such functionalities may also be combined together or with others.

The connectors are first manufactured, and their parts assembled together, then stored and delivered to the place where they are to be mounted on their respective cables. \

Once each device has received its connector, it is stored and delivered to the location where the various devices will be connected together through their respective connectors. For example, in the assembly of a motor vehicle, a wiring harness with a lever connector mounted on it is connected with an ECU that has a complementary counter connector mounted on it.

Each of the connectors is then mounted on its respective cable: the electrical contact(s) are crimped or soldered on the conductors or wire of the cable and are then fixed into the connector. This can be done, for example, directly in the connector housing, or in a module that is itself inserted into the connector housing.

During all of these operations, the connector is subject to shocks or unintentional stresses that can cause damage to it, for example, when parts are damaged or become detached. These incidents may result in loss of parts or even subassemblies, and/or time in the overall process, for example if the connector has to be replaced before connecting the harness to the ECU, or if the lever has fallen off and has to be found or replaced and reassembled on the housing.

One aim of the invention is to overcome some or all of the disadvantages of the prior art. In particular, it is intended to make the connector and its use more robust and more reliable, especially in some or all of the steps between its manufacture and its connection to its counter-connector.

Simultaneously, as power connector often comprise large contact terminals and need substantive effort for mating a connector (for example a female connector) with a counter-connector (for example a male connector), it is often provided a mate assist system that helps mating the connector and the counter-connector with each other, or that provide a mechanical locking effect between them.

Should such a connector be able to transmit a large amount of energy, either through a high intensity or under a quite high voltage, such as more than 48V, it is desirable that each individual electrical connection be robust and stable, despite wearing or possibly harsh external condition such as temperature or vibrations.

Also, it is desirable to enhance compactness of such a connector, and make it simpler and more ergonomic to manufacture, store and transport such connectors, to mount them on their cables, and to organize et operate their assembling and disassembling with their corresponding counter-connectors.

In particular, automotive connectors require a specific contact overlap length, for example more than 1 mm, to ensure proper electrical connection during lifetime and shouldn't cause acoustic noises in form of rattling or electromagnetic interferences.

### SUMMARY

These objectives are achieved partially or wholly, according to the disclosure, by a method or device having the features set forth in the claims. The claims form an integral part of the technical description provided herein in connection with the disclosure.

Thanks to these completion provisions, last part of the lever trajectory enables to provide a direct push on the electrical contacts, thus completing their mating with their counter contacts and providing a supplementary course resulting in an overlapping of their relative mating positions. Such completion action brings an effort in supplement of the driving portion effect, inter alia, because its action does not depend on the rigidity of the pivot shaft, because its action is more off-centered than action of the driving portion, while this completion action may incur less design constraints as it preferably comes only in a last part of the lever trajectory. As such completion action is preferably directly affected on an internal module that carries the contacts, the tolerance chain for obtaining the right completion action does not involve the holder of this module, thus making the manufacturing precision higher and/or the tolerance easier for each individual parts.

Thanks to the retention provisions, which are preferably provided by the same securing portion, the lever arm is less prone to get spread from the housing once it has been positioned in open position, and this lever is better retained on the connector housing during various step, such as when handled in bulk.

Such shapes and arrangement may be somehow more complex to design or manufacture when compared with the prior art, as an example because the retention element may be in an area separate from the joint.

However, in the disclosure, the lever and the connector housing happen to be more resilient and less breakable, as the retention element may be made on an internal face of the lever arm; oppositely to the prior art where it was often on the external face of the connector housing and thus more exposed to shocks.

Thus, features of the disclosure bring also advantages, such as through less damages to the levers and housing connectors when handled in bulk before their being assembled together. Also, as the retention functionality is now separate from the pivot area and functionality, there is more flexibility and less constraints for the design of the joint area.

### BRIEF DESCRIPTION OF THE DRAWINGS

FIG. 1 shows, in a perspective view partially on-scale, the connector housing with the lever mounted on it and positioned in the open position;

FIGS. 2a and 2b show on-scale the lever of FIG. 1, respectively in a perspective and in a front view parallel to its pivoting axis;

FIG. 3 shows the connector of FIG. 1, in a view perpendicular to the pivoting axis, with the lever schematically represented in insertion position, open position, and closed position;

FIGS. 4a and 4b show an on-scale detail of a lever joint of the connector of FIG. 1, viewed from the inside of its housing, respectively in front view and in perspective view, with the lever in the insertion position;

FIGS. 5a and 5b show an on-scale detail of a lever joint of the connector of FIG. 1, viewed from the inside of its housing, respectively in front view and in perspective view, with the lever in the open position;

FIGS. 6a and 6b show an on-scale detail of a lever joint of the connector of FIG. 1, viewed from the inside of its housing, respectively in front view and in perspective view, with the lever in closed position;

FIG. 7a shows a detail of a lever joint of the connector of FIG. 1, viewed in perspective, showing a possible position of the parting line in the area of the retention element for an example of design of a mold used for producing the lever;

FIG. 7b schematically shows from bottom the lever of FIG. 7a with the position of an exemplary parting line in a case of a two-part mold separating into only two opposite demolding directions;

FIG. 8 is a perspective view of the contact module of the same connector, without its cables nor electrical contacts, alone and assembled within its housing;

FIG. 9 and FIG. 9a show a front view of the same contact module, respectively in a global view and in a detailed view;

FIG. 10 and FIG. 10a show a front view of the same contact module within the connector housing, with the front wall of the housing and almost all of the contact module removed for clarity, respectively in a global view and in a detailed view, in a near-closed position before completion action;

FIG. 11 and FIG. 1la show a front view of the same contact module within the connector housing, with the front wall of the housing removed for clarity, respectively in a global view and in a detailed view, in its fully closed position after completion action;

FIG. 12 and FIG. 12a show a cut view of the connector mated with its counter-connector, respectively in a cut front view and in a cut transverse view.

### DETAILED DESCRIPTION

In the various figures, similar or identical elements have the same references.

FIG. 1 to FIG. 12a illustrate an exemplary embodiment of connector with a securing portion according to the disclosure, where a same portion 33, 331, 332 works both as a completion and a retention portion.

### Retention Action

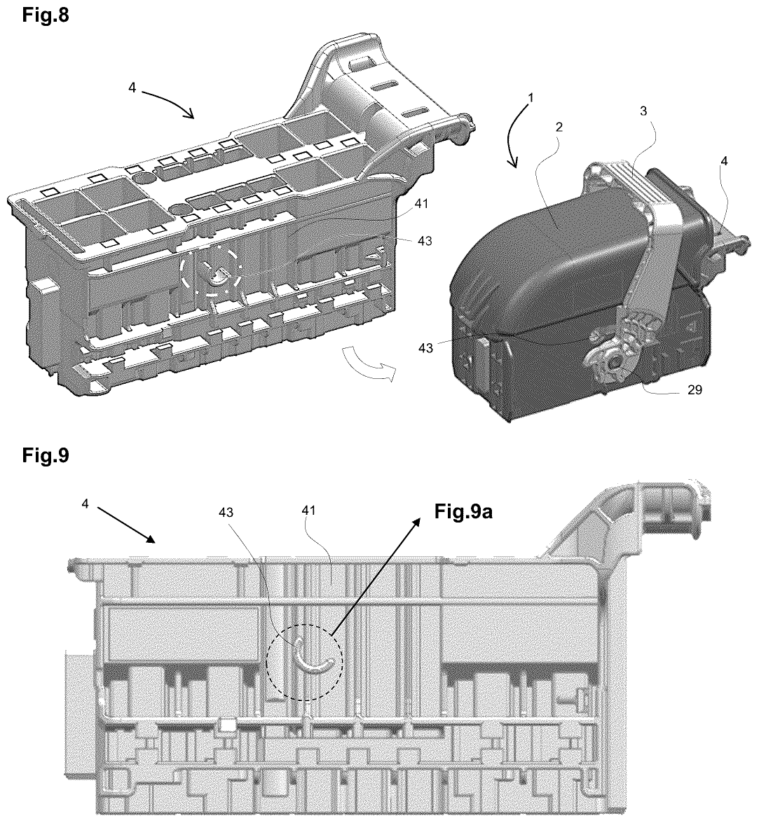

FIG. 1 partially shows connector 1, which has a connector housing 2 with a lever 3 mounted on it. The connector 1 illustrated here is arranged, for example in a manner known in the prior art, with an internal cavity 20 configured to receiving a contact module 4 to be inserted M4 into the connector housing 2. This module 4 is shown only schematically in FIG. 1, and more detailed in FIG. 8 to FIG. 10. This module 4 carries several electrical contacts 52, each of them being fixed to a different electrical conductor 51 within a cable 5. In this example, the connector 1 and its module 4 are designed for mating with a counter connector coming along a mating direction C4. However, such housing and lever may receive different kinds of electrical contacts, with or without a module, and different shapes and/or mating directions.

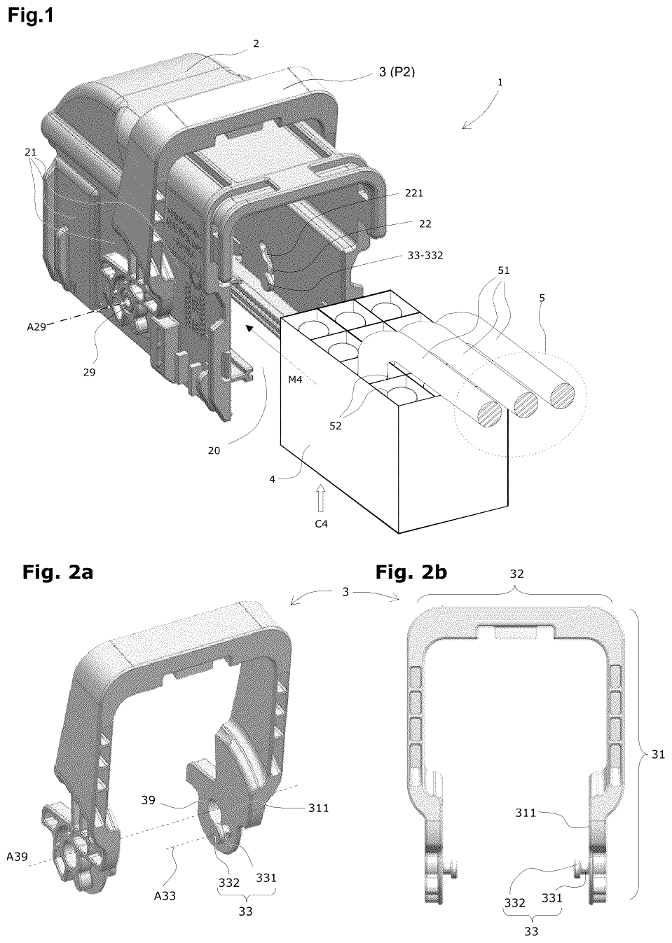

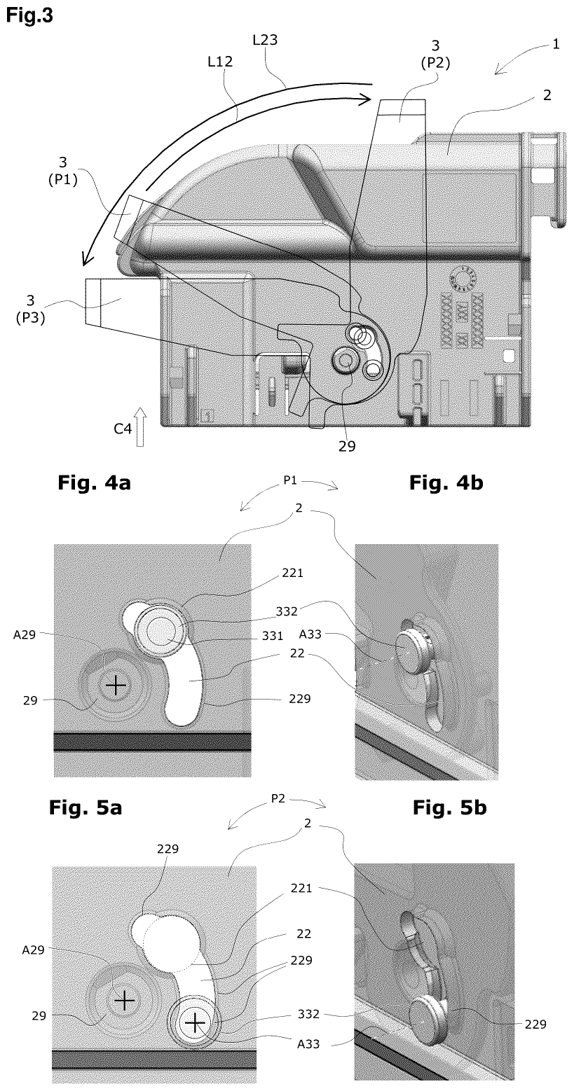

As illustrated also in FIG. 2a and FIG. 2b, the lever 3 has two parallel and symmetric lever arms 31, linked together by a knob 32 perpendicular to the lever arms 31. Each lever arm 31 has a pivot hole 39, which each receives a pivot 29 extending from an external face 21 of the connector housing 2. As illustrated in FIG. 3, the lever 3 can be pivoted around the axis A29 of the pivot 29 and pivot holes 39. It may be noted that the pivot 29 of the housing 2 does not extend outside the pivot hole 39 of the lever, and thus is protected from most potential shocks. Also, as the retention functionality is not assumed by the pivot 29 and pivot hole 39, the shape of them is simple and robust: the extremity of the pivot 29 is simply flat and tapered. Moreover, pivot hole 39 is here designed as a pass-through hole but could also be designed as a blind hole.

In an area separate from the pivotal joint 39-29, each lever arm 31 bears a circular and cylindrical extension 331 which extends outside of its internal face 311, here in a perpendicular direction A33. Along this extension axis A33, the extension 331 is followed by a retention protrusion 332, here transversal to the extension axis A33, forming a T-shape of a circular perimeter. As can be seen in FIG. 1 and FIG. 5 to FIG. 6, the extension 331 passes through a retention opening 22, and the retention protrusion 332 protrudes on two sides of the retention opening 22. Retention opening 22 is here disclosed as a pass-through opening but could also be embodied as a blind opening. Extraction of the retention element 33, and hence spreading of the lever arms 31, is thus prevented by the edges 229 of the opening 22. Extension 331 and retention protrusion 332 thus form together a retention element 33 which is integral with the lever 3 and its lever arm 31.

As illustrated, the transverse protrusion 332 of the retention element 33 preferably has a shape that is oval or circular around an extension axis A33 longitudinal to its extension 331.

FIG. 3 and FIG. 4 to FIG. 6 illustrate different positions of the lever 3 in regard to the connector housing 2, and various moves between them during the process of manufacturing and using the connector 1.

In FIGS. 4a and 4b is illustrated a detail of the pivot and retention areas, in a position P1 called assembly position, also shown schematically in FIG. 3. In this assembly position P1, the pivot hole 39 of the lever arm 31 is in regard of the pivot 29 of the housing 2. Also, the retention protrusion 332 is in regard to a portion of the retention opening 22 where its edges are more widely spaced, called an insertion hole 221, so as to enable insertion of the retention protrusion 332. In this position, the lever 3 is thus assembled to the housing 2, such as by elastically spreading the lever arms 31 and then inserting both pivot 29 into the pivot hole 39 and retention element 33 into the insertion hole 221. The internal edges 229 of the retention opening 22 have a shape sufficiently wide to allow the transverse protrusion 332 of the securing portion 33 working as a retention portion to pass through in a direction parallel to the extension 331 of the securing portion 33 working as a retention portion.

Once it is done, lever 3 is rotated through a move L12 toward another position P2, called open position, schematically shown in FIG. 3. As illustrated in detail in FIGS. 5a and 5b, this move L12 is guided by the extension 331 of the retention element 33 along a portion in an arc of circle of the retention opening 22. In this portion, its edges 229 are narrower than the retention protrusion 332 of the retention element 33, which can be seen extending over these retention edges 229. Thus, lever arms 31 are now retained by the housing 2 and cannot be taken off it, so that the lever being may not be detached and lost.

The connector 1, in its entirety or even just as the housing plus lever assembly, can then be handled transported and/or stored, individually or in bulk, with a limited risk of involuntary disassembly or breaking. This is still true once the connector 1 has been mounted on a cable 5 or another element for preparing a whole subassembly, such as a whole harness ready to be connected, including during transporting or storing or handling such subassembly and during the operation of connecting the subassembly with a counter connector.

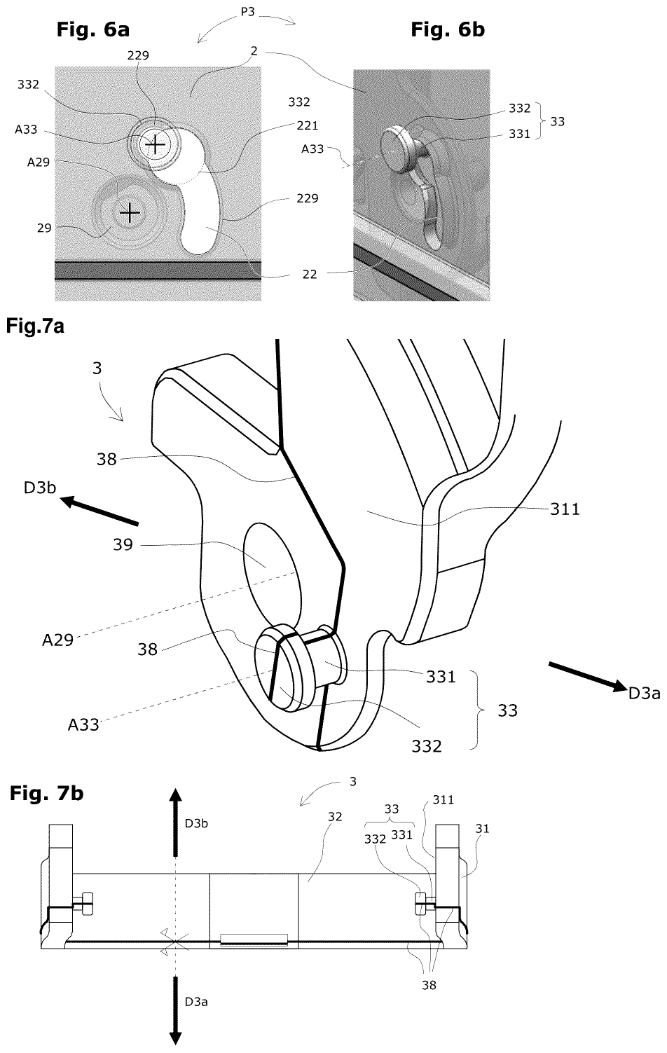

Afterward, when the connector 1 is mated to its counter connector, the lever 3 is rotated to still another position P3, called closed position, in a move L23 schematically shown in FIG. 3. In this closed position P3, as illustrated in detail in FIGS. 6a and 6b, extension 331 of the retention element 33 is in still another portion of the retention opening 22, also in a shape of an arc of circle, with its edges 229 still narrower than the retention protrusion 332 of the retention element 33. Thus, lever arms 31 are again retained by the housing 2 and cannot be taken off it, so that the lever being may again not be detached and lost.

The insertion hole 221 is advantageously located within the retention opening 22 in a position P1 different from the position of the securing portion 33 working as a retention portion both in open position P2 and in closed position P3.

As can be seen in FIG. 7a and FIG. 7b, the shape of such retention element 33 is compatible with a manufacturing process of the lever 3 by molding, such as a plastic injection molding, without causing a need for a supplementary mobile part of the mold, called slider or drawer or split. As a matter of fact, the shape of the retention protrusion 332 and extension 331 naturally have a sufficient angle of draft for making it possible to operate an unmolding movement in only two opposite direction D3a and D3b. Such a mold configuration is here illustrated through an exemplary parting line 38, produced by the parting surface between the two parts of such a mold. The lever arm 31 and the securing portion 33 working as a retention portion have a shape that is tapered on both sides of a same parting surface 38, thus allowing demolding of the lever without its transverse protrusion 332 creating by itself a need for a molding split.

It may be noted that the lever 3 may be mounted on and displaced on the connector housing 2 without needing any access to the internal cavity 20 of the latter, which provides freedom in designing the connector's shapes and kinematics.

Thanks to these provisions, once it has been positioned in open position, the lever arm 31 is less prone to get spread from the connector housing wall 21 and the lever 3 is better retained on the connector housing 2 during various step, such as when handled in bulk.

Such shapes and arrangement may be somehow more complex to design or manufacture when compared with the prior art, as an example because the retention element may be in an area separate from the joint.

However, in the disclosure, the lever and the connector housing happen to be more resilient and less breakable, as the retention element may be made on an internal face of the lever arm; oppositely to the prior art where it was often on the external face of the connector housing and thus more exposed to shocks.

Thus, features of the disclosure bring also advantages, such as through less damages to the levers and housing connectors when handled in bulk before their being assembled together. Also, as the retention functionality is now separate from the pivot area and functionality, there is more flexibility and less constraints for the design of the joint area.

### Completion Action on Contact Module

FIG. 8 to FIG. 12a illustrate more specifically the feature securing the connection by enhancing mating assistance which is provided by the same lever extension 33 interacting with the interior of the connector housing 2.

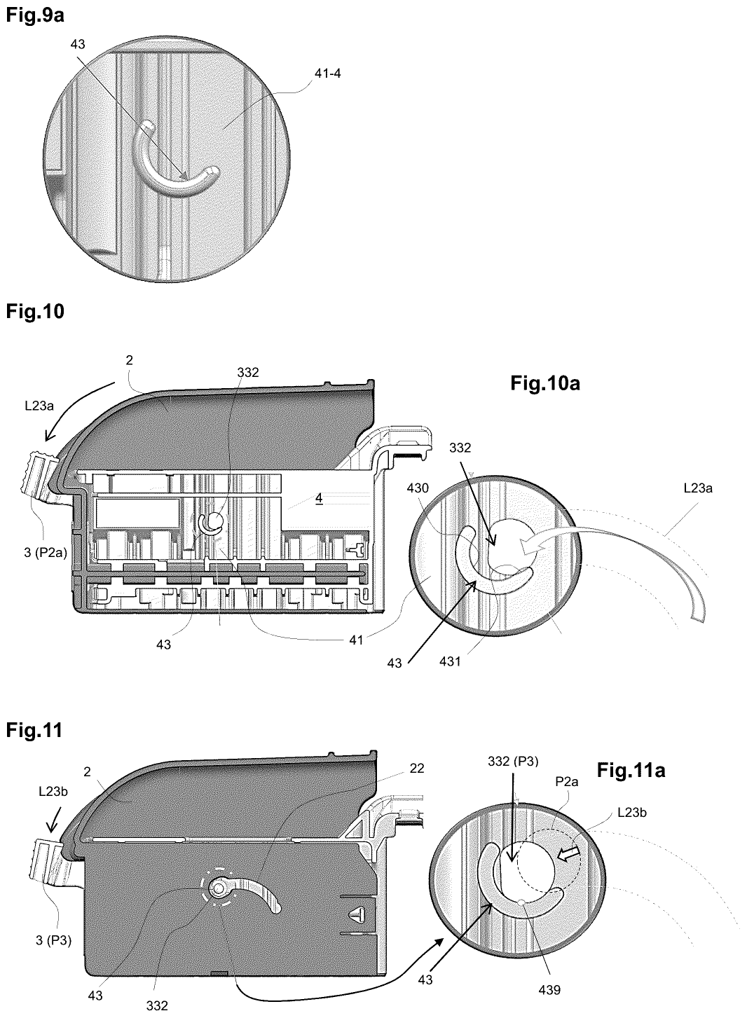

As illustrated in FIG. 8 to FIG. 9a, the module 4 itself comprises a module housing, the lateral wall 41 of which comprises a groove 24 with a defined final stop or contact point 439.

This groove is shaped as a semi-circular ridge and has beyond of that an eccentrical shape to the closing direction of the lever 3.

When closing L23 the lever, the T-shaped locking element 332 is pushing against the defined contact point 439 once it is fully closed, in position P3. The tolerance “chain” will be reduced; by having the force directly applied between lever 3, module 4 and the counter-connector 9.

The T-shaped locking element 332, or retention protrusion, which is useful to reduce spreading and accidental loss of the lever, is here be used in combination with an additional 43 feature on module wall 41, to improve contact overlap and reduce clearance and rattling of the connector when it its fully mated. Such combination is especially advantageous as the same extension part thus fulfils two concurrently useful functionalities while keeping a common ergonomics and reduced footprint.

The edge of the locking protrusion 332 is thus used for pushing the module 4 further towards the counter-connector 9.

The feature on the module housing needs only a defined flat or bidimensional contact point 430 to get a better contact overlap or like in the embodiment illustrated here with an eccentrical shape in form of a groove, which brings the advantage to combine it with another feature; and thus, to create a self-locking effect between lever and module. Due to the eccentrical shape on the groove, the T-shaped locking element engages versus the rotational movement over the axis A29 of the pivot pin 29 of the module holder 2. The contact surface 332 working as a completion portion may comprise a convex or circular shape and the contact surface 43 of the contact module 4 may comprise a complementary concave or circular shape 430 borne by a ridge 43 that protrudes from a wall of the contact module 4 that is facing the wall 21 of the housing 2. The complementary concave or circular shape 430 of the contact surface 43 of the contact module 4 has a part, notably rounded, that protrudes within a non-final part of the trajectory travelled by the contact surface 332 working as a completion portion. The final completion movement L23b of the contact surface 332 working as a completion portion is thus partially impeded in the closing direction as well as in the reverse direction. In other words, the final completion movement L23b of the contact surface 332 working as a completion portion has thus been made a bit more difficult in the closing direction as well as in the reverse direction. The contact surface 332, working as of a completion portion, of the lever provides its completion action by pushing on a contact surface 43 of the contact module 4 that has a shape complementary to the contact surface 332 working as of a completion portion 332, the shapes being convex for one of them and concave for the other.

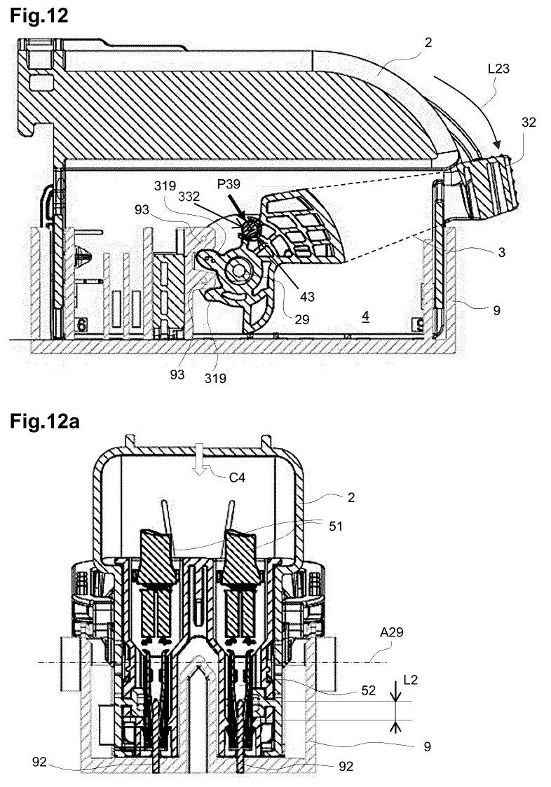

As illustrated in FIG. 12 and FIG. 12a, the lever 3 comprises a driving portion here exemplified as a set of two rotating teeth 319 borne by the lever, that engage in two translating teeth 93 of the counter connector 9. When the lever 3 is pivoted L23, its shaft 29 rotates the rotating teeth 319. The rotating teeth 319 then push the teeth 93 of the counter connector upwards, thus pulling the connector housing 2 towards the counter connector 9. Such driving mechanism is only an example and could be of another kind including a known mechanism.

As it will be understood, in supplement of the assisting mechanism 319-93, the final part L23b of the lever closing movement makes it pushing directly on the module 4. Oppositely, prior art assisting levers typically pushed only on the connector housing which itself pushed the module towards the counter connector, as it happens in the present driving portion 39-319. At least one of the contact surfaces among the contact surface 332 working as a completion portion and the contact surface 43 of the contact module 4 comprises advantageously a shape that is elastically deformable within a completion part L23b of a closing movement 23 of the lever 3, so as to provide a self-locking effect that tend to maintain the lever in its fully closed position P3.

In the present disclosure, the direct lever-to-module pushing action P39 thus gives a shorter tolerance loop, where the dimensions of the housing 2 and the gap between the connector housing 2 and the module 4 are not anymore involved. Thus, tolerance chain of module holder is reduced compared with prior art.

For example, it is thus possible to authorize a manufacturing tolerance for each part may be higher, which allow easier manufacturing and more flexible designing. It may also be used for providing a better guaranteed overlap, or a combination of such advantages.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector configured to be mated to a counter-connector, comprising:
a connector housing carrying one or more electrical contacts so as to ensure a connection of the contacts with one or more electrical counter-contacts carried by the counter-connector; and
at least one lever arranged to assist with mating the connector with the counter-connector, the lever comprising at least one lever arm that is linked with the connector housing by a joint, so as to be movable in regard to the connector housing, between at least:
an open position, in which the counter-connector can be at least partially mated to the connector, and
a closed position, in which the counter-connector is fully mated to the connector, wherein the lever further comprises a securing portion that extends towards and through an opening of a wall of the connector housing for providing a securing interaction between the lever and the housing.

2. The connector according to claim 1, wherein the lever comprises a driving portion with a shape configured to provide a contact cooperation with the counter-connector that enables a movement of the lever toward the closed position to bring the connector and counter-connector close to each other and wherein the securing portion has a contact surface that is arranged for, along at least one part of the closing movement, providing a completion action by pushing on the electrical contacts of the connector so as to enhance connection between the contacts and the counter-contacts, thus working as a completion portion.

3. The connector according to claim 2, wherein the connector housing contains a contact module that carries all or part of the electrical contacts and wherein the contact surface working as a completion portion is arranged for pushing on the electrical contacts through pushing on a contact surface of the contact module.

4. The connector according to claim 2, wherein the lever joint with the housing defines a pivot hole crossed by a pivot shaft that bears and drives the driving portion, wherein the contact surface working as a completion portion enforces the completion action along a completion direction that is more off-center than a driving direction of the driving portion, and wherein the contact surface working as a completion portion extends through an opening of the housing wall that is separate from the pivot hole.

5. The connector according to claim 3, wherein the contact surface working as a completion portion of the lever provides its completion action by pushing on a contact surface of the contact module that has a shape complementary to the contact surface working as a completion portion, the shapes being convex for one of them and concave for the other.

6. The connector according to claim 3, wherein at least one of the contact surfaces among the contact surface working as a completion portion and the contact surface of the contact module comprises a shape that is elastically deformable within a completion part of a closing movement of the lever, so as to provide a self-locking effect that tend to maintain the lever in its fully closed position.

7. The connector according to claim 4, wherein the securing portion comprises an extension that is able to slide within the opening and that is prolonged by a transverse protrusion which projects over internal edges of the opening, so as to retain the lever arm against the connector housing by resting on the internal edges.

8. The connector according to claim 3, wherein the contact surface working as a completion portion comprises a convex or circular shape and the contact surface of the contact module comprises a complementary concave or circular shape borne by a ridge that protrudes from a wall of the contact module that is facing the wall of the housing, and wherein the concave or circular shape has a part, notably rounded, that protrudes within a non-final part of a trajectory travelled by the contact surface working as a completion portion, a final completion movement of the contact surface working as a completion portion being partially impeded in a closing direction as well as in a reverse direction.

9. The connector according to claim 4, wherein the securing portion comprises an extension that is able to slide within the opening and that is prolonged by a transverse protrusion that rests on internal edges of the opening, then called a retention opening, so as to retain the lever arm against the connector housing by resting on the internal edges, both in the open position and in the closed position, the securing portion thus working as a retention portion.

10. The connector according to claim 9, wherein the opening has a portion forming an insertion hole, wherein the internal edges have a shape sufficiently wide to allow the transverse protrusion of the securing portion working as a retention portion to pass through in a direction parallel to the extension of the securing portion working as a retention portion, and wherein the insertion hole is located within the opening in a position different from the position of the securing portion working as a retention portion both in open position and in closed position.

11. The connector according to claim 9, wherein the transverse protrusion of the securing portion working as a retention portion has a T-shape in a section plane comprising an extension axis that is longitudinal to the extension.

12. The connector according to claim 9, wherein the lever arm and the securing portion working as a retention portion have a shape that is tapered on both sides of a same parting surface, thus allowing demolding of the lever without its transverse protrusion creating by itself a need for a molding split.

13. A method for manufacturing a connector, comprising:
providing the connector according to claim 10;
assembling the lever on the housing by inserting the securing portion into an insertion hole of the opening, in an assembly position; and
moving the lever from the assembly position to the open position, thereby allowing storage and delivery of the connector without the lever inadvertently detaching from the connector housing.

14. A method for electrically connecting two cables to each other, comprising:
manufacturing a connector according to the method of claim 13;
providing the connector to a mounting station;
mounting the connector on a first cable within the mounting station by fixing its electrical contacts therein;
coupling the connector to a counter connector mounted on a second cable; and
moving the lever to the closed position.

15. A method for electrically connecting two cables to each other, comprising:
providing the connector according to claim 2 to an assembling place, with its lever in an open position, and a counter-connector configured for mating with the connector;
positioning the connector and the counter-connector in a position suited for mating them with each other;
actuating the lever of the connector in a mating movement, towards a provisory mated position, thus having its driving portion cooperating with a driving portion of the counter-connector for producing an electrical connection between the electrical contacts of the connector and their respective counter-contacts within the counter-connector; and
actuating the lever in a completion movement, towards its closed position, thus providing an enhanced connection between the electrical contacts of the connector and their respective counter-contacts within the counter-connector, preferably with a continuation of a mating course of the contacts and counter-contacts in relation to each other along an overlap course.
